(19) United States
(12) Patent Application Publication
(10) Pub. No.: US 2009/0083266 A1
(43) Pub. Date: Mar. 26, 2009

(54) TECHNIQUES FOR TOKENIZING URLS

(76) Inventors: Krishna Leela Poola, Bangalore (IN); Arun Ramanujapuram, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/935,622

(22) Filed: Nov. 6, 2007

(30) Foreign Application Priority Data
Sep. 20, 2007 (IN) 2113/CHE/2007

(51) Int. Cl. G06F 17/30

(52) U.S. Cl. 707/6; 707/102; 707/E17.009; 707/E17.017

(57) ABSTRACT

Techniques are described for tokenizing a corpus of URLs of web documents. URLs are first tokenized based upon specified generic delimiters to form components. The components are then tokenized using website-specific delimiters. Website-specific delimiters are any non-alphanumerical symbol or a unit change that is specific to a particular website. Support for website-specific delimiters and the tokens resulting from website-specific delimiters are calculated. Support values for website-specific delimiters and the tokens above a specified threshold value are valid. Tokenization may also be performed by generating a graph of the corpus of URLs of web documents. Each node of the graph represents a token and each edge represents a delimiter of the URLs. The graph is traversed and the support of the edges are compared to a specified threshold value. If the support of an edge of a node is greater, then the token corresponding to the node is valid.

### CROSS REFERENCE TO RELATED APPLICATIONS

This application is related to and claims the benefit of priority from Indian Patent Application No. 2113/CHE/2007 filed in India on September 20, 2007, entitled “TECHNIQUES FOR TOKENIZING URLS”; the entire content of which is incorporated herein by this reference thereto and for all purposes as if fully disclosed herein.

### FIELD OF THE INVENTION

The present invention relates to URLs, and specifically, to tokenizing URLs to extract keywords.

### BACKGROUND

As the popularity and size of the Internet has grown, categorizing and extracting information on the Internet has become more difficult and resource intensive. This information is difficult to categorize and manage due to the sheer size and complexity of the information on the Internet. Furthermore, the information comprising the Internet continues to grow and change each day. Categorizing information on the Internet may be based upon many criteria. For example, information may be categorized by the content of the information in a web document. Thus, if a user searches for specific content, the user may enter a keyword into a search engine. In response, web documents that relate to the keyword are returned to the user. Unfortunately, determining content by analyzing each web document is tedious and requires large amounts of computing resources. As a result, more efficient and faster methods to categorize and extract information from the Internet would be beneficial.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a URL and the URL's components, according to an embodiment of the invention;

FIGS. 2A and 2B are diagrams of a flowchart that describes steps to perform URL tokenization, according to an embodiment of the invention;

FIG. 3A illustrates a corpus of URLs on which to perform URL tokenization, according to an embodiment of the invention;

FIG. 3B is a diagram of a graph of tokens and delimiters of the URLs from FIG. 3A to perform URL tokenization, according to an embodiment of the invention; and

FIG. 4 is a block diagram of a computer system on which embodiments of the invention may be implemented.

### DETAILED DESCRIPTION

Techniques are described to determine tokens and delimiters of URLs in a URL corpus. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

To manage and categorize information on the Internet, web documents may be classified and ranked based upon keywords. As used herein, “keywords” refers to particular words that indicate the subject matter or content of a web document. For example, a web document about portable computers from a computer manufacturer might be categorized under the keyword “laptop.” In addition to helping to manage information, keywords allow Internet search engines to locate and list web documents that correspond to the keyword.

Keywords may be generated from a variety of sources including, but not limited to, the web document itself and the URL of the document. In an embodiment, keywords are extracted from the web document itself. This may be performed by analyzing the entire text of a particular web document and selecting words that summarize or indicate the subject matter of the particular web document. However, extracting keywords from a web document may lead to high computing resource costs. For example, while processing the text of a single web document might not be taxing, scaling the process to include all of the web documents on the Internet results in an extremely resource-intensive task.

In an embodiment, keywords are extracted from the URL of a web document. A URL is first tokenized into candidate keywords based on a tokenization algorithm. Once the candidate keywords are identified, the candidate keywords are ranked based on relevance and performance. The ranked keywords may then be used for managing and categorizing information on the Internet. Extracting keywords from the URL of a web document is highly scalable and less resource-intensive than extracting keywords from the web document itself because the amount of information processed is significantly less.

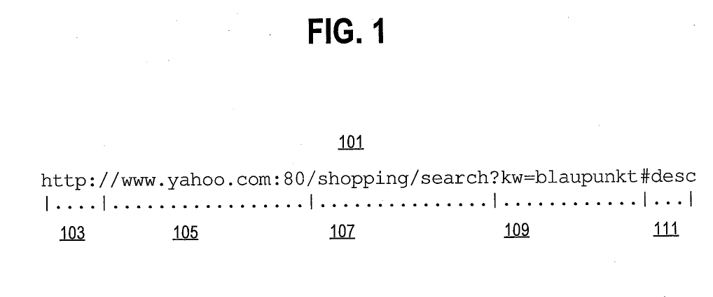

A uniform resource locator (URL) is the global address of web documents and resources located on the Internet. Each web document or resource on the Internet is mapped to one or more particular URLs. To locate and retrieve a particular document, the URL of the document may be entered into a web browser or other information retrieval application. In response, the document is retrieved. An example of a URL is illustrated in FIG. 1. In FIG. 1, URL 101 is shown as “http://www.yahoo.com:80/shopping/search?kw=blaupunkt#desc.” URLs are composed of five different components: (1) the scheme 103, (2) the authority 105, (3) the path 107, (4) query arguments 109, and (5) fragments 111.

Each component of a URL provides different functions. Scheme 103 identifies the protocol to be used to access a resource on the Internet. Two examples of protocols that may be used are “HTTP” and “FTP.” Hypertext Transfer Protocol (“HTTP”) is a communications protocol used to transfer or convey information on the World Wide Web. File Transfer Protocol (“FTP”) is a communications protocol used to transfer data from one computer to another over the Internet, or through a network. Authority 105 identifies the host server that stores the web documents or resources. A port number may follow the host name in the authority and is preceded by a single colon “:”. Port numbers are used to identify data associated with a particular process in use by the web server. In FIG. 1, the port number is “80.” Path 107 identifies the specific resource or web document within a host that a client wishes to access. The path component begins with a slash character “/.” Query arguments 109 provide a string of information that may be used as parameters for a search or as data to be processed. Query arguments comprise a string of name and value pairs. In FIG. 1, query argument 109 is “kw=blaupunkt.” The query parameter name is “kw” and the value of the parameter is “blaupunkt.” Fragments 111 are used to direct a web browser to a reference or function within a web document. The separator used between query arguments and fragments is the “#” character. For example, a fragment may be used to indicate a subsection within the web document. In FIG. 1, fragment 111 is shown as “#desc.” The “desc” fragment may reference a subsection in the web document that contains a description.

In addition to categorizing and managing information on the Internet, extracting keywords from the URL has use in other applications. For example, advertisements may be generated for a web document based on tokens generated from the document's URL. The tokens generated by URL tokenization may also be assigned with features of the web document to improve the efficiency of a web search. Tokenizing URLs is also the first step when clustering URLs of a website. Clustering URLs allows the identification of portions of a web document that hold more relevance. Thus, when a website is crawled by a search engine, some portions of web documents may be white-listed and should be crawled, while other portions may be black-listed and should not be crawled. This leads to more efficient web crawling.

### Tokenizing URLs

In an embodiment, a URL of a document is tokenized based upon generic and web-specific delimiters. As used herein, “generic delimiters” refers to characters that may be used to tokenize URLs of any website and are previously specified. As used herein, “website-specific delimiters” are used to tokenize URLs of only a particular website. A “website” refers to a collection of web documents that are hosted on one or more web servers. The pages of a website may be accessed from a common root URL with other URLs of the website organized into a hierarchy. The tokens of the URL are then analyzed and ranked to determine whether any of the tokens may be used as keywords.

### Generic Delimiters

In an embodiment, generic delimiters may include, but are not limited to, the characters “/,” “?,” “&,” and “=.” Each of the generic delimiters separate different components of a URL. For example, the character, “/,” separates the authority, path, and separate tokens of the path component of a URL. The character, “?,” separates the path component and the query argument component. The character, “&,” separates the query argument component of a URL into one or more parameter name and value pairs. The character, “=,” separates parameter names and parameter values in the query arguments component of the URL.

When a URL has been tokenized based upon generic delimiters, the resulting tokens are indexed by level number. For example, using the example in FIG. 1, “http://www.yahoo.com:80/shopping/search?kw=blaupunkt#desc,” the first token would be “http:” and have an index or level number of “1.” The second token would be “www.yahoo.com:80” with an index or level number of “2.” The third token would be “shopping” with an index or level number of “3.” The fourth token would be “search” with an index or level number of “4.” The fifth token would be “kw” with an index or level number of “5.” The sixth token would be “blaupunkt” with an index or level number of “6.” The seventh token would be “desc” with an index or level number of “6.”

### Website-Specific Delimiters

Website-specific delimiters are used by the particular website's developer when naming the site's URLs. Website-specific delimiters are useful because many potential keywords may be overlooked if tokenization is based only upon generic delimiters. URLs which illustrate this shortcoming are in the following examples:

1) “http://www.laptop-computer-discounts.com/discount-amazon-cat-1205234-sku-B00006B7G9-item-256mb_pc100_sdram_or_toshiba2”

2) “http://www.myspacenow.com/cartoons-looneytunes1.shtml”

3) “http://reviews.designtechnica.com/review224_intro1117.html”

In the first example, tokenizing based on generic delimiters alone would result in the token “discount-amazon-cat-1205234-sku-B00006B7G9-item-256mb_pc100_sdram_for_toshiba2.” Because of the size and amount of information in the token, this token is not a good candidate for use as a keyword. Many potential keywords, such as “discount,” “amazon,” and “toshiba,” are lost because the potential keywords are unable to be separated from other information. In the second example, tokenizing based on generic delimiters alone would result in the token “cartoons-looneytunes1.shtml.” Under such circumstances, neither “cartoons” nor “looneytunes” would be used as keywords because they would be located in the same token and could not be separated. In the third example, tokenizing based on generic delimiters alone would result in the token “review224_intro1117.html.” Under such circumstances, “review” could not be used as a keyword because the word is located in the same token as the other information and cannot be separated.

Tokenization based on website-specific delimiters is performed by searching for pattern changes in URLs of a website. The process of determining website-specific delimiters and tokenization based on the website-specific delimiters may be referred to as “deep tokenization.” Deep tokenization finds patterns generated by either (1) a website-specific delimiter or (2) a unit change to tokenize URLs into multiple tokens. Unless otherwise mentioned, a website-specific delimiter may refer to pattern changes by either (1) a website-specific delimiter or (2) a unit change.

In an embodiment, website-specific delimiters are special characters where the special character may not be an alphabet, number, or a generic delimiter. Special characters may be defined by identifying the ASCII code to which a character corresponds. ASCII codes are codes based on the American Standard Code for Information Interchange that define 128 characters and actions. For example, numbers “0, 1, 2, . . . , 9” correspond to ASCII codes “48, 49, 50, . . . , 57.” Upper case letters “A, B, C, . . . , Z” correspond to ASCII codes “65, 66, 67, . . . , 90.” Lower-case letters “a, b, c, . . . , z” correspond to ASCII codes “97, 98, 99, . . . , 122.” The generic delimiters are “/” (ASCII code “47”), “?” (ASCII code “63”), “&” (ASCII code “38”), and “=” (ASCII code “61). ASCII codes “0 through “31” are non-printing characters. Thus the special characters may be the characters that correspond to ASCII codes 32-37, 39-46, 58-60, 62-64, 91-96, and 123-127. For example, in the example “256_MB,” the special character “_” (ASCII code “95”) might be used as a website-specific delimiter that generates the tokens “256” and “MB.”

In an embodiment, a unit change is also used to determine website-specific delimiters in URLs. As used herein, a unit is a sequence of either letters from the alphabet or numbers. For example, in the sequence “256MB,” “256” is one unit and “MB” is another unit. “256” is a unit because “256” is a sequence of numbers. “MB” is another unit because “MB” is a sequence of letters and not numbers. The change from one type of unit to another may define a website-specific delimiter. Deep tokenization based on this unit change would generate tokens “256” and “MB.”

In an embodiment, tokens generated by deep tokenization are indexed by sub-level numbers. Sub-levels are another set of levels or sub-divisions generated on top of levels generated by generic delimiters. Sub-level numbers are employed because deep tokenization is performed on each index level found by the generic tokens.

In an embodiment, the decision to tokenize a URL with website-specific delimiters is based upon other factors and techniques including, but not limited to, delimiter support, token support, and look ahead. Each of these concepts is discussed in further detail below.

In an embodiment, delimiter support determines whether a website-specific delimiter may be used for tokenization. As used herein, “delimiter support” is calculated as a percentage of the URLs in a website that have the same sub-levels as the URL under consideration (in one embodiment, a website's URLs are considered one at a time for tokenization purposes) and have the same delimiter occurring at the current sub-level. If the delimiter support of a delimiter is more than an earlier specified delimiter support threshold (“DST”), then the delimiter may be considered for tokenization.

In an embodiment, token support determines whether the tokens generated by tokenizing with website-specific delimiters are useful and not merely noise. Noise refers to tokens that offer no relevance to the content of a web document. An example of noise is a token corresponding to the parameter “session-id.” “Session-id” identifies a user with a particular process but has no relevance when determining the content of the web document. In an embodiment, a user-specified list of “noisy” tokens indicates which tokens should be considered mere “noise.”

As used herein, token support is calculated by the formula: “[[(A−B)/A]* 100].” “A” represents the number of URLs under consideration from the same domain or website and “B” represents the number of distinct tokens at the current sub-level. If the token support at a sub-level is greater than the earlier specified token support threshold (“TST”), then the sub-level is considered tokenized.

In an embodiment, “look-ahead” refers to ignoring a current delimiter or token and moving forward in a URL until a pattern with a delimiter support greater than DST or token support greater than TST is found. Look-ahead may be used where the current delimiter has delimiter support less than the value of the DST. The current sub-level is ignored and a look-ahead is performed to find the next delimiters that have a delimiter support greater than DST. For example, the website-specific delimiter “˜” may have delimiter support less than the DST because there are not many instances of the website-specific delimiter “˜.” In this particular case, look-ahead might be used to find website-specific delimiters that present more meaningful patterns. Look-ahead helps by removing noisy delimiters and tokens whose support is less than the threshold value.

### Tokenization Algorithm

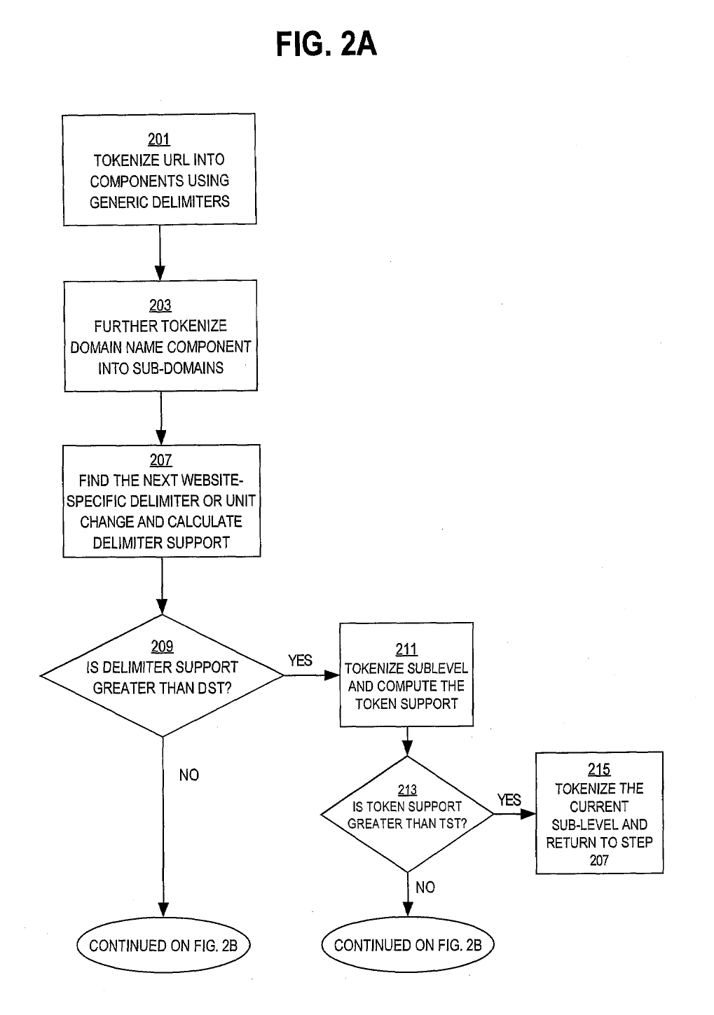

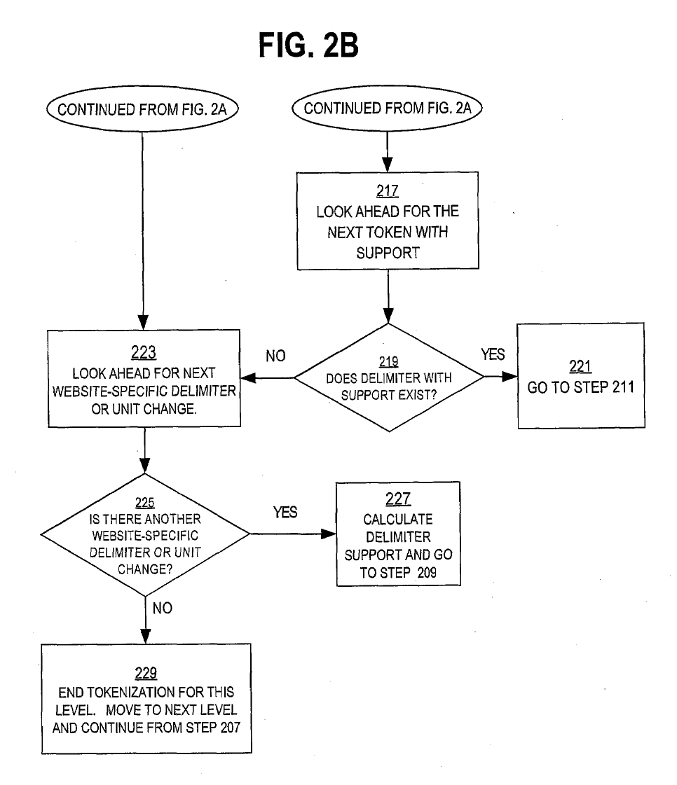

In an embodiment, tokenization is performed by tokenizing the URL based on generic delimiters and then web-specific delimiters. An illustration of this technique is illustrated in the flowchart shown on FIGS. 2A and 2B. In step 201, URLs are tokenized based upon generic delimiters. The tokens are indexed with a level number. Tokenizing the URL with generic delimiters yields the following components: scheme, domain name, multiple path components, script name, and query argument pairs.

In an embodiment, a server tokenizes the domain name into multiple sub-domains as shown in step 203. In this step, each label to the left of the delimiter “.” specifies a sub-division or a sub-level. For example, “yahoo.com” comprises a sub-domain of the “com” domain, and “movies.yahoo.com” comprises a sub-domain of the domain “yahoo.com.”

In an embodiment, the URL is then tokenized based on website-specific delimiters. Website-specific delimiters may be determined based upon the support of the delimiter and the support of the token.

In order to find website-specific delimiters, each level formed by generic delimiter tokenization is analyzed. First, as shown in step 207, a determination is made as to whether a website-specific delimiter or a unit change has occurred on the level. As previously mentioned, a website-specific delimiter may refer to either a website-specific delimiter (special character) or a unit change. If a website-specific delimiter is found, then a delimiter support value of the website-specific delimiter is calculated. Then in step 209, the delimiter support value is compared to the delimiter support threshold (DST).

If the value for delimiter support is more than the DST, as seen in step 211, then the website-specific delimiter is used to tokenize a sub-level. The value for the sub-level token support is calculated and compared to the token support threshold (TST) in step 213. As shown in step 215, if the token support is greater than the TST, then the current sub-level is tokenized and the next delimiter is determined by a return to step 207. Although the support of a token is used as a measure for tokenization, support values may be extended to any other measure that is able to differentiate between informative and noisy tokens.

As shown in step 217, if the token support value is less than the value for TST, then a look-ahead is performed by searching for another website-specific delimiter with support greater than DST in the same level. As shown in step 219, a determination is made as to whether a website-specific delimiter with support greater than DST exists. If no such delimiter exists, as shown in step 223, then a look-ahead is performed to find the next website-specific delimiter or unit change. If a delimiter with support exists, as shown in step 221, then the algorithm moves to step 211 where the sublevel is tokenized and token support is calculated.

If the delimiter support value is less than the value for DST, as shown in step 223, then a look-ahead is performed to find a website-specific delimiter or unit change. In step 225, a determination is made as to whether a website-specific delimiter exists. If another web-specific delimiter is found, as shown in step 227, then delimiter support is calculated and the algorithm continues at step 209. If the look-ahead results in no delimiters as seen in step 229, then tokenization is terminated for these tokens at this level and then deep tokenization is performed for the next level by moving to the next level and continuing at step 207. If tokenization has reached the end of the URL, then the algorithm is terminated and the URL tokenization is completed.

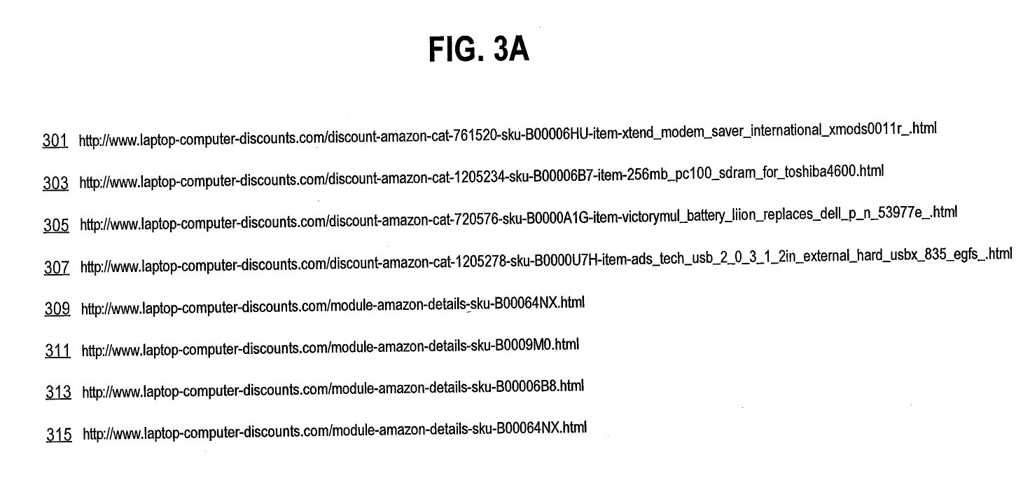

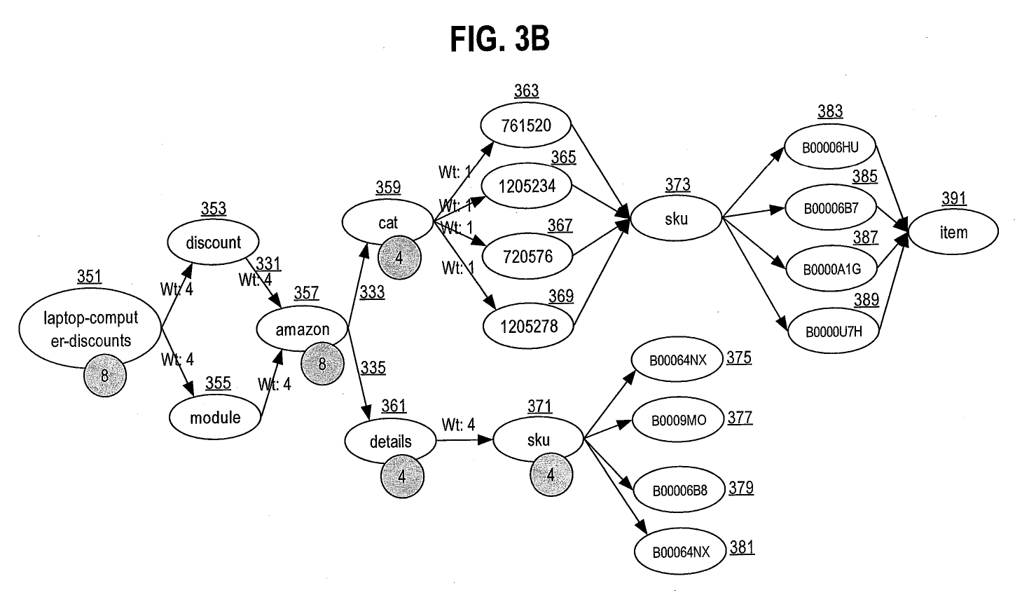

An example of URLs of a website are shown in FIG. 3A. Eight URLs are displayed for the website “www.laptop-computer-discounts.com.” Each URL contains a scheme, an authority component, and a single path. For example, the path in URL 301 is “discount-amazon-cat-761520-sku-B00006HU-item-xtend_modem_saver_international_xmods001r” and the path in URL 309 is “module-amazon-details-sku-B00064NX.” The paths in URLs 301, 303, 305, and 307 begin with “discount-amazon-cat- . . . . ” The paths in URLs 309, 311, 313, and 315 begin with “module-amazon-details-sku- . . . . ”

To illustrate the tokenization algorithm, the set of eight URLs from FIG. 3A is used as an example. URLs are first tokenized based upon generic delimiters. For URL 309, a token “http:” with an index level of “1,” a token “www.laptop-computer-discounts.com” with an index level of “2,” and a token “module-amazon-details-sku-B00064NX.html” with an index level of “3” results. The domain “www.laptop-computer-discounts.com” is further tokenized into sub-domains separated by a “.” “www.laptop-computer-discounts.com” comprises a sub-domain of the “laptop-computer-discounts.com” domain and “laptop-computer-discounts.com” comprises a sub-domain of the “com” domain.

Though each level of the URL is considered, level “3” is used as an example to determine website-specific delimiters. Level “3” is “module-amazon-details-sku-B00064NX.html.” Possible website-specific delimiters in level “3” that are special characters are the symbol “-” that occurs after “module,” the symbol “-” that occurs after “amazon,” the symbol “-” that occurs after “details,” the symbol “-” that occurs after “sku,” and the symbol “.” that occurs after “NX.” Possible website-specific delimiters in level “3” that are unit changes are the unit change after “B” but before “0064” and the unit change after “0064” but before “NX.”

First, the delimiter support is calculated. The delimiter support for the symbol “-” that occurs after “module” is calculated as the percentage of the URLs in a website that have the same sub-levels as the URL under consideration and have the same delimiter occurring at the current sub-level. The sub-level of the delimiter “-” that occurs after “module” is “3.1” as the delimiter occurs in level “3” and is the first delimiter of level “3.” Four URLs (309, 311, 313, and 315) out of the eight URLs in FIG. 3B have the same sub-levels as the URL under consideration and have the same delimiter occurring at the current sub-level. Thus, the delimiter support is 50%. If the delimiter support threshold is 25% (delimiter support greater than DST), then the delimiter is used to tokenize the sub-level. If the delimiter support threshold is 75% (delimiter support not greater than DST), then a look ahead is performed to find the next delimiter.

In the circumstance that delimiter support is greater than DST, the token support is calculated for the sub-level “module.” Token support is calculated by the formula “[[(A−B)/ A]*100].” “A” represents the number of URLs under consideration and “B” represents the number of distinct tokens at the current sub-level. In the example, the number of URLs under consideration is “8” and the number of distinct tokens at the current sub-level is “2.” There are two distinct tokens at the current sub-level because URLs 309, 311, 313, and 315 all have the token “module” at sub-level “3.1” while URLs 301, 303, 305, and 307 all have the token “discount” at sub-level “3.1.” Token support is thus [(8−2)/8]*100=75. If the token support threshold is 50 (token support greater than TST), then the current sub-level is tokenized. If the delimiter support threshold is 90 (token support not greater than TST), then a look ahead is performed to find the next sub-level. These steps repeat for each of the possible website-specific delimiters, whether by special character or unit change, for the URL.

### Graph Algorithm

In an embodiment, tokenization is performed by analyzing a graph of the URLs of a website. The graph is composed of nodes (or states) that are connected to other nodes by an edge (or transition). Each node of the graph represents a token. The edge from one node to another node represents a website-specific delimiter or a unit change. To construct the graph, URLs for a website are tokenized based upon website-specific delimiters and unit changes. Nodes are formed for each token based on website-specific delimiters and unit changes. Edges that connect nodes represent the website-specific delimiter or unit change between tokens.

Edges and nodes in the graph also contain an associated weight. The associated weight of an edge from one node to another node is equal to the number of times the two tokens (nodes) occurred together with the corresponding delimiter (edge) in the corpus of URLs. The associated weight of a particular node is equal to the sum of all the weights of inward edges into the particular node. In an embodiment, the associated weight is based upon measurements from Information Theory. These may include, but is not limited to, support, entropy, or some such measure employed in Information Theory. Further discussion on Information Theory may be found in the reference, “A Mathematical Theory of Communication” by C. E. Shannon (Bell System Technical Journal, vol. 27, pp. 379-423, 623-656, July, October, 1948), which is incorporated herein by reference.

An example of using a graph to tokenize URLs of a website is shown in FIGS. 3A and 3B. The URLs of a website are shown in FIG. 3A. The graph corresponding to these URLs is shown in FIG. 3B. The graph shown in FIG. 3B corresponds to the URL corpus shown in FIG. 3A. The node 351 contains the token “laptop-computer-discounts” because the token is the authority of each of the URLs in FIG. 3A. For simplification, node 351 may also be referred to as the “laptop-computer-discounts” node 351. The “laptop-computer-discounts” node 351 has an associated weight of “8” because the token is in all eight URLs of the corpus. Associated weights of nodes are illustrated in the graph with a grey circle and number connected to the node. Not all associated weights to nodes and edges are displayed on the graph. From the “laptop-computer-discounts” node 351, two edges connect to the “discount” node 353 and the “module” node 355. The edge to the “discount” node 353 has an associated weight of “4” because the delimiter connecting “laptop-computer-discounts” to “discount” in the corpus of URLs of FIG. 3A occurs in four instances (in URLs 301, 303, 305, and 307). This is indicated in the graph by the label “Wt:4” located on the edge.

The “discount” node 353 and the “module” node 355 connect to the “amazon” node 357. The “amazon” node is connected to the “cat” node 359 and “details” node 361. The “cat” node 359 is connected to the “761520” node 363, the “1205234” node 365, the “720576” node 367, and the “1205278” node 369. These four nodes are then connected to the “sku” node 373. The “sku” node is connected to the “B0006HU” node 383, the “B00006B7” node 385, the “B0000A1G” node 387, and the “B0000U7H” node 389. These last four nodes are then connected to the “item” node 391. The “details” node 361 is connected to the “sku” node 371. The “sku” node 371 is connected to the “B00064NX” node 375, the “B0009M0” node 377, the “B00006B8” node 379, and the “B00064NX” node 381.

In an embodiment, determining whether to tokenize a URL is based on delimiter support, token support and look-ahead. Starting from the root node of the graph, the graph is traversed from node to node as long as the edge support is greater than the delimiter support threshold (“DST”). Because each edge represents a delimiter, the edge support is the delimiter support of the URLs.

If the edge support (delimiter support) value is greater than the value for DST, then the current node (token) is valid and tokenized. The algorithm then analyzes the outgoing edges from the second node from the edge. If the edge support value is less than the value for DST, then the graph is traversed until a node is found that is pointed to by all the nodes of the previous level. This occurs where the in-degree (number of incoming edges) of the node is equal to the number of nodes in the previous level. If a node is not found where the in-degree is equal to the number of nodes from the previous level, the traversal is ended at the first node. Other nodes from the graph from the same level are then analyzed recursively using the same steps.

In order to illustrate the algorithm, the set of URLs in FIGS. 3A and 3B are analyzed with DST set to a value of “3.” Starting from the root node 351 “laptop-computer-discounts,” the root node 351 has a weight value of “8” which is greater than the value of the DST. The associated weights of nodes found at the next level, which from the example are the “discount” node 353 and the “module” node 355 have associated values of “4”. Thus, the “discount” node 353 and the “module” node 355 have associated values is greater than the value of DST. These nodes may then be considered for traversal.

The current traversal set now includes the “discount” node and the “module” node. The “discount” node 353 connects to the “amazon” node 357 with edge 331 having an associated weight of “4.” The associated weight of edge 331 is greater than the value of DST. The “amazon” node 357 may then be considered for the next traversal. From the “amazon” node 357, a traversal is made to the “cat” node 359 that has out-going edges with a weight less than the value of DST. Because the value of the out-going edges is less, a traversal is made from the next node until a node is found where the in-degree is equal to the number of nodes at the previous level. The nodes first encountered are the “761520” node 363, the “1205234” node 365, the “720576” node 367, and the “1205278” node 369.

A traversal is made from these nodes to find a node where the in-degree is equal to the number of nodes at the previous level. In this example, the “sku” 373 node has an in-degree (four in-degrees) equal to the number of nodes (four, from the “761520” node 363, the “1205234” node 365, the “720576” node 367, and the “1205278” node 369) at the previous level. After processing all traversals in the graph originating from the “discount” node 353, the same steps are used to perform traversals from the “module” node 355.

### Hardware Overview

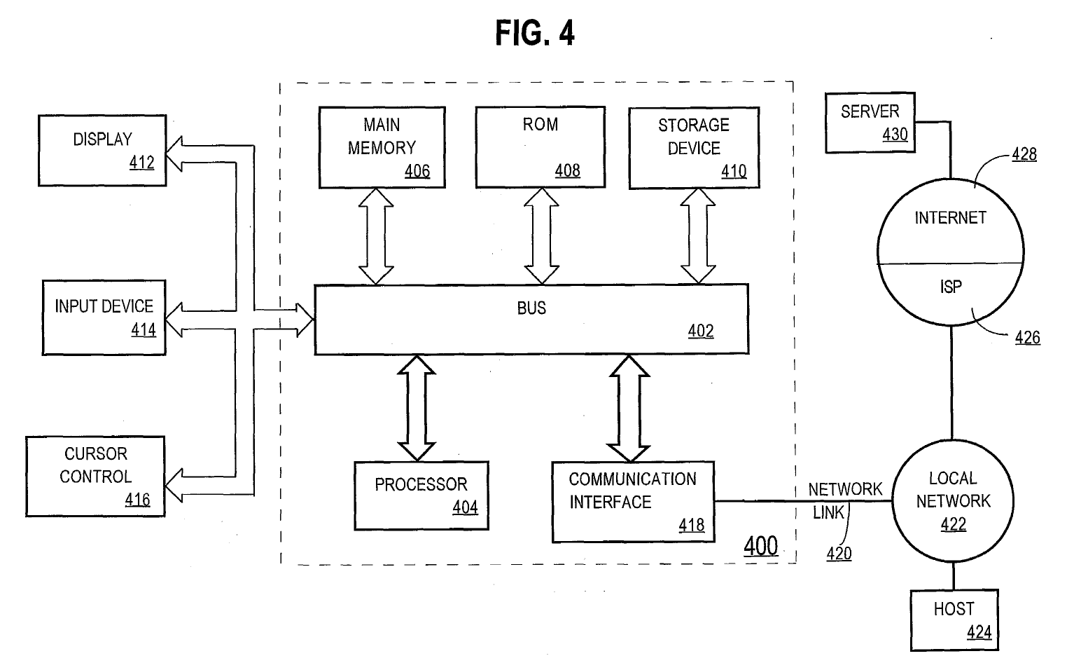

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for tokenizing URLs, comprising:
tokenizing, based upon generic delimiters, URLs of each of a plurality of documents of a website into a plurality of components;
for each particular component of the plurality of components, locating website-specific delimiters in the particular component;
calculating a delimiter support threshold for each particular website-specific delimiter of located site-specific delimiters;
determining whether delimiter support for each particular website-specific delimiter is greater than a specified delimiter support threshold;
in response to determining that the site specific delimiter support for the particular website-specific delimiter is greater than the specified delimiter support threshold, tokenizing the particular component based upon the particular website-specific delimiter;
for each particular token of the particular component, calculating a token support threshold for the particular token;
determining whether token support for the particular token is greater than a specified token support threshold; and
in response to determining that the token support for the component token is greater than the specified token support threshold, using the particular token to generate a description of the website.

2. The method of claim 1, wherein generic delimiters comprise the characters “/,” “\” “&,” and “=”.

3. The method of claim 1, wherein locating website-specific delimiters further comprises identifying, in the particular component, a change of one particular type of character to another type of character, not of the particular type.

4. The method of claim 3, wherein types of characters comprise (1) a number type or (2) a letter type.

5. The method of claim 1, wherein website-specific delimiters comprise the characters corresponding to ASCII codes 32-37, 39-46, 58-60, 62-64, 91-96,and 123-127.

6. The method of claim 1, wherein delimiter support is calculated by determining a percentage of URLs of the plurality of documents of the website that have the same delimiter in the same location of the URL.

7. The method of claim 1, wherein token support is calculated by:
subtracting a number of distinct tokens in a same location of a URL by a number of URLs of the plurality of documents of a website to calculate a difference;
dividing the difference by the number of URLs of the plurality of documents to calculate a quotient;
multiplying the quotient by 100 to calculate the token support.

8. The method of claim 1, wherein token support and delimiter support are based upon measures from Information Theory.

9. A method of tokenizing URLs, comprising:
tokenizing, based upon generic delimiters and website-specific delimiters, URLs of each of a plurality of documents of a website into a plurality of components;
generating a graph wherein (a) each node of the graph represents components and (b) edges connecting the nodes represent delimiters;
associating a weight to each node and each edge;
for each particular node of the graph, traversing from the particular node to another node connected by an edge;
comparing the weight of the edge to a specified delimiter support threshold;
if the weight of the edge is greater than the specified delimiter support threshold, then including the node in a set of validated nodes;
if the weight of the edge is not greater than the specified delimiter support threshold, then traversing the graph until reaching a node where the number of incoming edges is equal to the number of nodes in a previous level; and
generating a description of the website based at least in part on the validated nodes.

10. The method of claim 9, wherein the weight of a node is a number of occurrences the component of the node occurs in the URLs of the plurality of documents in a same location of the URL.

11. The method of claim 9, wherein the weight of an edge is a number of occurrences the components, corresponding to the nodes connected by the edge, occurs together with the delimiter, corresponding to the edge, in the URLs of the plurality of documents.

12. The method of claim 9, wherein the weight of an edge and the weight of a node are based upon measures from Information Theory.

13. A computer-readable storage medium carrying one or more sequences of instructions which, when executed by one or more processors, causes the one or more processors to:
tokenize, based upon generic delimiters, URLs of each of a plurality of documents of a website into a plurality of components;
for each particular component of the plurality of components, locate website-specific delimiters in the particular component;
calculate a delimiter support threshold for each particular website-specific delimiter of located site-specific delimiters;
determine whether delimiter support for each particular website-specific delimiter is greater than a specified delimiter support threshold;
in response to determining that the site specific delimiter support for the particular website-specific delimiter is greater than the specified delimiter support threshold, tokenize the particular component based upon the particular website-specific delimiter;
for each particular token of the particular component, calculate a token support threshold for the particular token;
determine whether token support for the particular token is greater than a specified token support threshold; and
in response to determining that the token support for the component token is greater than the specified token support threshold, use the particular token to generate a description of the website.

14. The computer-readable storage medium of claim 13, wherein generic delimiters comprise the characters “/” “!,” “&,” and “=”.

15. The computer-readable storage medium of claim 13, wherein locating website-specific delimiters further comprises identifying, in the particular component, a change of one particular type of character to another type of character, not of the particular type.

16. The computer-readable storage medium of claim 15, wherein types of characters comprise (13) a number type or (14) a letter type.

17. The computer-readable storage medium of claim 13, wherein website-specific delimiters comprise the characters corresponding to ASCII codes 32-37, 39-46, 58-60, 62-64, 91-96, and 123-127.

18. The computer-readable storage medium of claim 13, wherein delimiter support is calculated by determining a percentage of URLs of the plurality of documents of the website that have the same delimiter in the same location of the URL.

19. The computer-readable storage medium of claim 13, wherein token support is calculated by:
subtracting a number of distinct tokens in a same location of a URL by a number of URLs of the plurality of documents of a website to calculate a difference;
dividing the difference by the number of URLs of the plurality of documents to calculate a quotient;
multiplying the quotient by 100 to calculate the token support.

20. The computer-readable storage medium of claim 13, wherein token support and delimiter support are based upon measures from Information Theory.

21. A computer-readable storage medium carrying one or more sequences of instructions which, when executed by one or more processors, causes the one or more processors to:
tokenize, based upon generic delimiters and website-specific delimiters, URLs of each of a plurality of documents of a website into a plurality of components;
generate a graph wherein (a) each node of the graph represents components and (b) edges connecting the nodes represent delimiters;
associate a weight to each node and each edge;
for each particular node of the graph, traverse from the particular node to another node connected by an edge;
compare the weight of the edge to a specified delimiter support threshold;
if the weight of the edge is greater than the specified delimiter support threshold, then include the node in a set of validated nodes;
if the weight of the edge is not greater than the specified delimiter support threshold, then traverse the graph until reaching a node where the number of incoming edges is equal to the number of nodes in a previous level; and
generate a description of the website based at least in part on the validated nodes.

22. The computer-readable storage medium of claim 21, wherein the weight of a node is a number of occurrences the component of the node occurs in the URLs of the plurality of documents in a same location of the URL.

23. The computer-readable storage medium of claim 21, wherein the weight of an edge is a number of occurrences the components, corresponding to the nodes connected by the edge, occurs together with the delimiter, corresponding to the edge, in the URLs of the plurality of documents.

24. The computer-readable storage medium of claim 21, wherein the weight of an edge and the weight of a node are based upon measures from Information Theory.
